(19) United States
(12) Patent Application Publication
(10) Pub. No.: US 2021/0004644 A1
(43) Pub. Date: Jan. 7, 2021

(54) STORE APPARATUS, STORE SYSTEM, IMAGE ACQUISITION METHOD AND PROGRAM

(71) Applicant: NEC CORPORATION, Tokyo (JP)

(72) Inventors: Soma SHIRAISHI, Tokyo (JP); Kota IWAMOTO, Tokyo (JP); Tsugunori TAKATA, Tokyo (JP); Hideo YOKOI, Tokyo (JP); Emi KITAGAWA, Tokyo (JP); Saiprasad Chandrakant KOTURWAR, Tokyo (JP)

(73) Assignee: NEC CORPORATION, Tokyo (JP)

(21) Appl. No.: 16/977,279

(22) PCT Filed: Mar. 2, 2018
(86) PCT No.: PCT/JP2018/008145

§ 371 Date: Sep. 1, 2020

(51) Int. Cl. G06K 9/62; G06K 9/32; G06Q 20/20; G06Q 30/00; G06Q 10/08; G06N 20/00

(52) U.S. Cl. CPC G06K 9/6256; G06K 9/6262; G06K 9/3233; G06N 20/00; G06Q 20/203; G06Q 30/0185; G06Q 10/087; G06Q 20/208

(57) ABSTRACT

A store system (1) includes a store apparatus (10), an image capturing apparatus (30), and a display (40) that is also used as a placement surface of a product (P). The image capturing apparatus (30) generates an image in which the product (P) placed on a display surface of the display (40) is captured. The store apparatus (10) includes an image acquisition unit (110) that acquires an image generated by the image capturing apparatus (30), a mode switching unit (120) that switches between a product registration mode for registering a product to be purchased by a customer and an image collection mode for collecting a learning image of a discriminator for identifying a product, a product registration unit (130) that registers, during the product registration mode, a product identified by the discriminator, based on the image, as a product to be purchased, a display control unit (140) that displays, during the image collection mode, a predetermined background image on the display surface of the display (40), and an image collection unit (150) that stores, in a predetermined storage apparatus, an image in which the background image and the product (P) are captured as the learning image.

### TECHNICAL FIELD

The present invention relates to a product recognition technique using an image.

### BACKGROUND ART

One example of techniques for recognizing a product using an image is disclosed in PTL 1 described below, for example. PTL 1 described below discloses a product registration apparatus including functions of identifying a target captured by a camera as a product by performing object recognition on the target, and registering the product as a product to be purchased.

### CITATION LIST

### Patent Literature

[PTL 1] Japanese Unexamined Patent Application Publication No. 2016-62545

### SUMMARY OF INVENTION

### Technical Problem

In order to recognize a product by using an image, a great number of images for learning and an evaluation needs to be prepared for each product to be identified, and work for constructing a discriminator by using the images is needed. Then, in order to save time and effort for the work, outsourcing and preparation of a dedicated apparatus are conceivable, but, in such case, a cost increases.

The present invention has been made in view of the above-described problem. One of objects of the present invention is to provide a technique for reducing a cost for constructing a discriminator being used for identifying a product.

### Solution to Problem

A store apparatus according to the present invention includes:

an image acquisition unit that acquires, from an image capturing apparatus, an image in which a product placed on a display surface of a display is captured;

a mode switching unit that switches between a product registration mode for registering a product to be purchased by a customer and an image collection mode for collecting a learning image of a discriminator for identifying a product;

a product registration unit that registers, during the product registration mode, a product identified by the discriminator based on the image as a product to be purchased;

a display control unit that displays, during the image collection mode, a predetermined background image on the display surface of the display; and

an image collection unit that stores, in a predetermined storage apparatus, an image in which the background image and the product are captured, as the learning image.

A store system according to the present invention includes:

a display including a display surface used as a placement surface of a product;

an image capturing apparatus that generates an image in which a product placed on the display surface of the display is captured;

an image acquisition unit that acquires the image generated by the image capturing apparatus;

a mode switching unit that switches between a product registration mode for registering a product to be purchased by a customer and an image collection mode for collecting a learning image of a discriminator for identifying a product;

a product registration unit that registers, during the product registration mode, a product identified by the discriminator based on the image as a product to be purchased;

a display control unit that displays, during the image collection mode, a predetermined background image on the display surface of the display; and

an image collection unit that stores, in a predetermined storage apparatus, an image in which the background image and the product are captured, as the learning image.

An image acquisition method according to the present invention executed by a computer includes:

acquiring, from an image capturing apparatus, an image in which a product placed on a display surface of a display is captured;

switching between a product registration mode for registering a product to be purchased by a customer and an image collection mode for collecting a learning image of a discriminator for identifying a product;

registering, during the product registration mode, a product identified by the discriminator based on the image as a product to be purchased;

displaying, during the image collection mode, a predetermined background image on the display surface of the display; and

storing, in a predetermined storage apparatus, an image in which the background image and the product are captured, as the learning image.

A program according to the present invention causes a computer to execute the image acquisition method described above.

### Advantageous Effects of Invention

According to the present invention, a cost for constructing a discriminator being used for identifying a product can be reduced.

### BRIEF DESCRIPTION OF DRAWINGS

The above-described object, the other objects, features, and advantages will become more apparent from suitable example embodiments described below and the following accompanying drawings.

FIG. 1 is a diagram illustrating a configuration example of a store system according to a first example embodiment.

FIG. 2 is a block diagram illustrating a hardware configuration of a store system.

FIG. 3 is a diagram illustrating a flow of processing executed during a product registration mode by a store system according to the first example embodiment.

FIG. 4 is a diagram illustrating a flow of processing executed during an image collection mode by a store system according to the first example embodiment.

FIG. 5 is a diagram illustrating one example of information stored in a predetermined storage apparatus by an image collection unit.

FIG. 6 is a diagram illustrating a configuration example of a store system according to a third example embodiment.

FIG. 7 is a diagram illustrating one example of information displayed on a display by a display control unit according to the third example embodiment.

FIG. 8 is a diagram illustrating a configuration example of a store system according to a fourth example embodiment.

FIG. 9 is a flowchart illustrating a flow of learning processing executed by a store system according to the fourth example embodiment.

FIG. 10 is a diagram illustrating a configuration example of a store system 1 according to a fifth example embodiment.

FIG. 11 is a sequence diagram illustrating a flow of processing of the store system 1 according to the fifth example embodiment.

FIG. 12 is a diagram illustrating a first technique of extracting a product region image from a captured image.

FIG. 13 is a diagram illustrating a second technique of extracting a product region image from a captured image.

FIG. 14 is a diagram illustrating a third technique of extracting a product region image from a captured image.

FIG. 15 is a diagram illustrating another example of the third technique.

FIG. 16 is a diagram illustrating a fourth technique of extracting a product region image from a captured image.

FIG. 17 is a diagram specifically illustrating an operation of an image generation unit 154.

### EXAMPLE EMBODIMENT

Hereinafter, example embodiments of the present invention will be described by using drawings. It should be noted that, throughout the drawings, like constituent elements are denoted by like reference signs and the description thereof will not be repeated where appropriate. Unless otherwise mentioned, the blocks in the block diagrams represent functional components, not hardware components.

### First Example Embodiment

### System Configuration Example

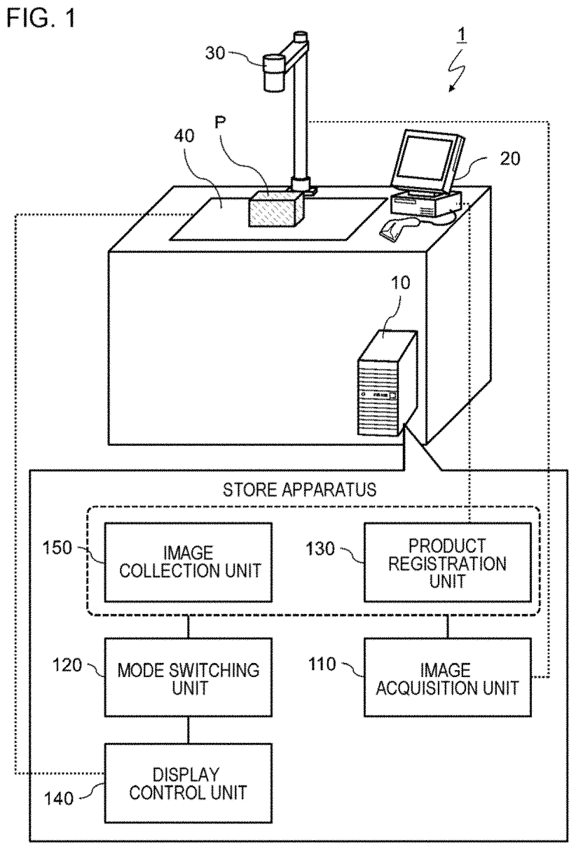

FIG. 1 is a diagram illustrating a configuration example of a store system 1 according to a first example embodiment. It should be noted that FIG. 1 is merely exemplification, and the store system 1 according to the present invention is not limited to the configuration illustrated in FIG. 1. As illustrated in FIG. 1, the store system 1 includes a store apparatus 10, a checkout processing apparatus 20, and an image capturing apparatus 30. The store apparatus 10 is connected to the checkout processing apparatus 20, the image capturing apparatus 30, and a display 40 with not-illustrated wiring and the like.

The store apparatus 10 can execute processing of collecting a learning image of a discriminator for identifying a product in addition to processing related to general register work. Each function of the store apparatus 10 will be described later.

The checkout processing apparatus 20 is various types of apparatuses used for register work at a store. For example, the checkout processing apparatus 20 includes a bar code scanner, a cash register, a drawer, an automatic change machine, a receipt printer, an input apparatus such as a keyboard and a mouse, and an output apparatus such as a display (touch panel display) and a speaker.

The display 40 displays various images on a display surface thereof. Further, the display 40 displays a specific background image according to control by the store apparatus 10 described later. Further, as illustrated, the display surface of the display 40 is also used as a placement surface on which a product P is placed.

The image capturing apparatus 30 generates an image in which the product P is captured. Further, as illustrated in FIG. 1, the image capturing apparatus 30 is disposed in such a way as to include the display 40 in an image capturing range. The image capturing apparatus 30 can capture the product P placed on the display surface of the display 40 with an image displayed on the display surface of the display 40 as a background. The image generated by the image capturing apparatus 30 is transmitted to the store apparatus 10.

As illustrated in FIG. 1, the store apparatus 10 according to the present example embodiment includes an image acquisition unit 110, a mode switching unit 120, a product registration unit 130, a display control unit 140, and an image collection unit 150. The image acquisition unit 110 acquires an image in which the product P placed on the display surface of the display 40 is captured from the image capturing apparatus 30. The mode switching unit 120 switches an operation mode of the store system 1 (store apparatus 10) between a product registration mode and an image collection mode. The product registration mode is a mode for executing processing of registering a product purchased by a customer. In other words, the product registration mode is a mode for executing processing of a general register apparatus. Meanwhile, the image collection mode is a mode for collecting a learning image of a product identification engine (discriminator) for identifying a product. The product registration unit 130 operates in the above-described product registration mode. The product registration unit 130 registers a product identified by the discriminator, based on an image acquired by the image acquisition unit 110, as a product to be purchased. In other words, the product registration unit 130 is a processing unit that executes processing related to normal register work by using an image acquired by the image acquisition unit 110. For example, the product registration unit 130 outputs information about a purchase product identified based on an image acquired by the image acquisition unit 110 to the display 40 or a display provided as the checkout processing apparatus 20. The display control unit 140 and the image collection unit 150 operate in the image collection mode. The display control unit 140 displays a predetermined background image on the display surface of the display 40. The image collection unit 150 acquires, as a learning image of the discriminator, an image in which the background image displayed on the display surface of the display 40 by the display control unit 140 and the product P placed on the display surface of the display 40 are captured. Then, the image collection unit 150 stores the image acquired as the learning image of the discriminator in a predetermined storage apparatus. Herein, for example, the predetermined storage apparatus may be a non-volatile storage apparatus such as a hard disk drive, and may be a volatile storage apparatus such as a random access memory (RAM).

### Hardware Configuration Example

The store system 1 may be achieved by hardware (for example, a hard-wired electronic circuit, and the like) that achieves each functional component unit, and may be achieved by a combination (for example, a combination of an electronic circuit and a program that controls the electronic circuit, and the like) of hardware and software. Hereinafter, a case where the store system 1 is achieved by the combination of hardware and software will be further described.

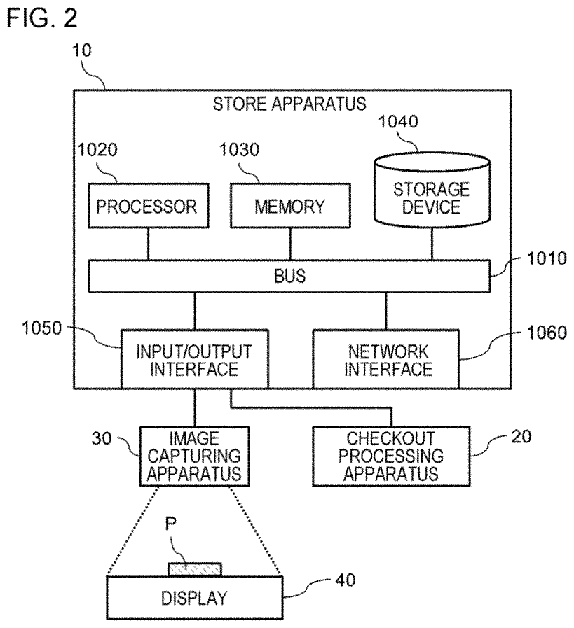

FIG. 2 is a block diagram illustrating a hardware configuration of the store system 1.

The store apparatus 10 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method for connecting the processor 1020 and the like to each other is not limited to a bus connection.

The processor 1020 is a processor achieved by a central processing unit (CPU), a graphics processing unit (GPU), and the like.

The memory 1030 is a main storage achieved by a random access memory (RAM) and the like.

The storage device 1040 is an auxiliary storage achieved by a hard disk drive (HDD), a solid state drive (SSD), a memory card, a read only memory (ROM), or the like. The storage device 1040 stores program modules that achieve the functions (the image acquisition unit 110, the mode switching unit 120, the product registration unit 130, the display control unit 140, the image collection unit 150, and the like) of the store apparatus 10. The processor 1020 reads each of the program modules onto the memory 1030 and executes the program module, and thereby each function corresponding to the program module is achieved.

The input/output interface 1050 is an interface for connecting the store apparatus 10 and various types of input/output devices. In FIG. 2, the store apparatus 10 is connected to the checkout processing apparatus 20, the image capturing apparatus 30, and the display 40 via the input/output interface 1050. For example, the checkout processing apparatus 20 includes a cash register, a drawer, an automatic change machine, a receipt printer, an input apparatus such as a keyboard and a mouse, and an output apparatus such as a display (touch panel display) and a speaker. The image capturing apparatus 30 is a camera equipped with, for example, a charge coupled device (CCD) image sensor or a complementary metal oxide semiconductor (CMOS) image sensor. As illustrated, the image capturing apparatus 30 is installed in such a way as to include the display 40 (and the product P placed on the display 40) in the image capturing range. The image capturing apparatus 30 captures the product P placed on the display 40 and generates an image in which the product P is captured. The display 40 is a general display device. It should be noted that the display 40 is also used as the placement surface of the product P. Thus, the display 40 is preferably a flat-panel display such as a liquid crystal display (LCD), a plasma display panel (PDP), and an organic electro luminescence (EL). Further, the display 40 may be a touch panel that can receive an input operation of a user.

The network interface 1060 is an interface for connecting the store apparatus 10 to a network. The network is, for example, a local area network (LAN) or a wide area network (WAN). A method by which the network interface 1060 connects to a network may be a wireless connection or a wired connection.

FIG. 2 is merely one example, and the hardware configuration of the store system 1 is not limited to the example in FIG. 2. For example, the store apparatus 10 may be connected to the checkout processing apparatus 20 and the image capturing apparatus 30 via the network interface 1060. Further, the display 40 may display various types of product registration work screens instead of the display of the checkout processing apparatus 20. In this case, the display of the checkout processing apparatus 20 may not be installed.

### <Flow of Processing>

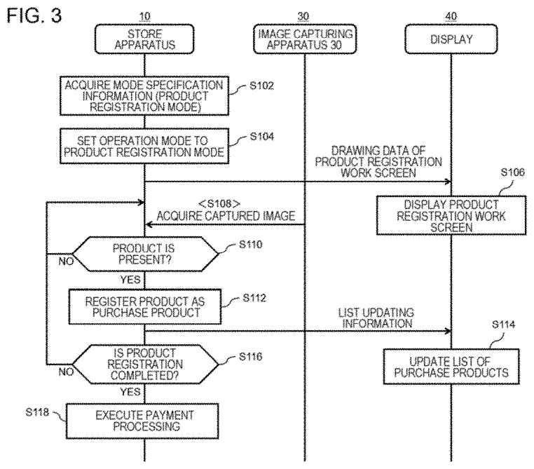

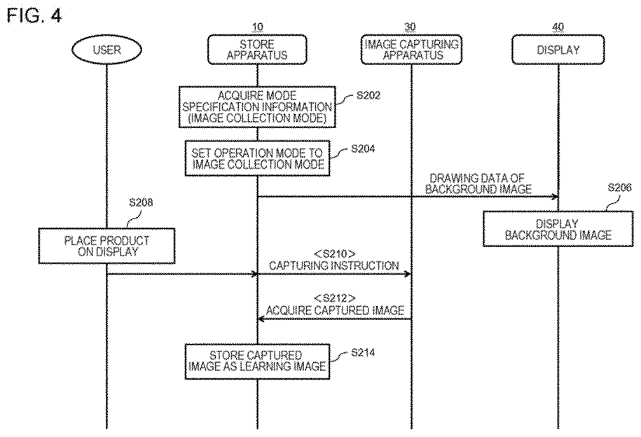

A flow of processing executed by the store system 1 according to the present example embodiment will be described by using FIGS. 3 and 4. FIG. 3 is a diagram illustrating a flow of processing executed during the product registration mode by the store system 1 according to the first example embodiment. Further, FIG. 4 is a diagram illustrating a flow of processing executed during the image collection mode by the store system 1 according to the first example embodiment.

### <Processing During Product Registration Mode>

First, the flow of the processing during the product registration mode will be described by using FIG. 3.

First, a user (salesclerk) who uses the store system 1 performs an operation of switching an operation mode of the store system 1 to the “product registration mode”. The operation is, for example, an operation of switching a not-illustrated switch and the like connected to the store apparatus 10, an operation of pressing a switching button displayed on the display 40 or the display of the checkout processing apparatus 20, and the like. Information (mode specification information) that specifies a mode of the store system 1 is generated in response to the operation, and is transmitted to the store apparatus 10.

When the store apparatus 10 acquires the mode specification information (herein, the information that specifies the “product registration mode”) generated by the operation as described above (S102), the mode switching unit 120 sets the operation mode of the store system 1 to the product registration mode (S104). Then, the store apparatus 10 causes the display 40 to display the product registration work screen (S106). Further, processing illustrated as follows is executed in response to the operation mode of the store system 1 being set to the product registration mode by the mode switching unit 120.

The image acquisition unit 110 acquires a captured image generated by the image capturing apparatus 30 (S108). For example, the image capturing apparatus 30 always outputs a sensing result (captured image) of an image sensor to the image acquisition unit 110. Further, the image capturing apparatus 30 may be configured in such a way as to generate an image according to an instruction of the image acquisition unit 110. Then, the product registration unit 130 determines whether a product is present in the captured image acquired by the image acquisition unit 110 (S110). For example, the product registration unit 130 can determine whether a product is present in the captured image (or a feature value extracted from the captured image) acquired by the image acquisition unit 110, based on an output result acquired by inputting the captured image to the product identification engine. In addition, the product registration unit 130 may detect a region of an object from the captured image by using an edge feature value and the like, and then determine whether the object is a product by performing template matching and the like.

When a product is not present in the captured image (S110: NO), the image acquisition unit 110 acquires a new captured image generated by the image capturing apparatus 30, and the product registration unit 130 determines whether a product is present in the new captured image.

On the other hand, when a product is present in the captured image (S110: YES), the product registration unit 130 registers the product (product identified by the product identification engine and the like) as a product to be purchased (S112). For example, the product registration unit 130 can perform the following operation. First, the product registration unit 130 acquires, as an identification result of the product identification engine and the like, information (for example, identification information about the product) indicating what the product is. Herein, when a plurality of products are placed on the display 40, the product identification engine can output a result acquired by identifying each of the products. Then, the product registration unit 130 acquires information needed for product registration, based on the information acquired from the product identification engine. For example, the product registration unit 130 can acquire, based on the identification information about a product acquired from the product identification engine, information (for example, a product name, a product price, with or without benefits, and the like) related to the product. Then, the product registration unit 130 generates information that updates a product list of products to be purchased by using the information related to the product acquired in such a manner. For example, the product registration unit 130 transmits, to the checkout processing apparatus 20, the product list to which the information related to the product identified in the processing in S110 is added. Further, the product registration unit 130 may transmit, to the checkout processing apparatus 20, the information related to the product identified in the processing in S110, as updating information. The display 40 updates a display content of the product list of products to be purchased, based on the information acquired from the product registration unit 130 (S114).

The image acquisition unit 110 and the product registration unit 130 repeatedly execute the above-described processing until a termination instruction of the processing of registering a product to be purchased is detected (S116: NO). For example, the image acquisition unit 110 and the product registration unit 130 repeatedly execute the above-described processing until a button (such as a subtotal button) to be pressed after all purchase products are registered is pressed. Then, when the subtotal button or the like is pressed (S116: YES), the image acquisition unit 110 and the product registration unit 130 terminate the above-described processing. Subsequently, the store apparatus 10 executes payment processing (S118).

It should be noted that, when a display is provided as the checkout processing apparatus 20, the product registration unit 130 may transmit a list of purchase products to the display instead of or in addition to the display 40 in the above-described processing. Further, when a bar code reader or the like is provided as the checkout processing apparatus 20, the product registration unit 130 may update a list of purchase products by using information acquired from the bar code reader.

### <Image Collection Mode>

Next, the flow of the processing during the product registration mode will be described by using FIG. 4.

First, a user (salesclerk) who uses the store system 1 performs an operation of switching an operation mode of the store system 1 to the “image collection mode”. The operation is, for example, an operation of switching a not-illustrated switch and the like connected to the store apparatus 10, an operation of pressing a switching button displayed on the display 40 or the display of the checkout processing apparatus 20, and the like. Information (mode specification information) that specifies a mode of the store system 1 is generated in response to the operation, and is transmitted to the store apparatus 10.

When the store apparatus 10 acquires the mode specification information (herein, the information that specifies the “image collection mode”) generated by the operation as described above (S202), the mode switching unit 120 sets the operation mode of the store system 1 to the image collection mode (S204). Processing illustrated as follows is executed in response to the operation mode of the store system 1 being set to the image collection mode by the mode switching unit 120.

The display control unit 140 causes the display 40 to display a predetermined background image (S206). The background image may be an image (for example, a combination image formed of random geometrical figures, and the like) being randomly generated. Further, for example, the background image may be an image tuned for a usage environment of the product identification engine. For example, a display content such as a screen actually displayed in work at a store and a graphical user interface (GUI), a hand or a finger of a person, or the like may be included as noise in at least a part of the background image. By including such noise in the background image, a situation that may actually occur in a usage environment (specifically, a system for collectively recognizing products to be purchased, which are placed on the display 40, by using the image capturing apparatus 30 in the upper portion) of the product identification engine can be accurately reconstituted. The background image is previously stored in the storage device 1040 and the like, for example. The display control unit 140 can read the background image from the storage device 1040 and the like and output the background image to the display 40.

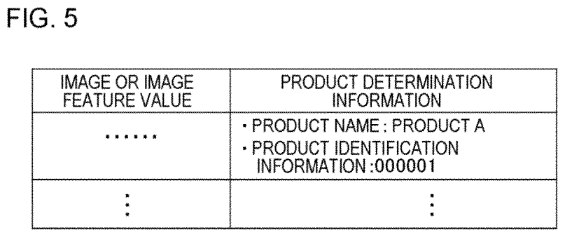

Further, a user who uses the store system 1 places the product P to be learned by the product identification engine on any position on the display 40 (S208). Subsequently, a user who uses the store system 1 instructs a capturing operation to the image capturing apparatus 30 via an input apparatus (such as a keyboard and a touch panel) connected to the store apparatus 10 (S210). The image capturing apparatus 30 generates an image in which the background image displayed on the display surface of the display 40 and the product P placed on the display surface of the display 40 are captured according to the capturing instruction from the image acquisition unit 110. Then, the image acquisition unit 110 acquires the image generated by the image capturing apparatus 30 (S212). The image collection unit 150 stores the image acquired in S212 as a learning image in a predetermined storage apparatus (for example, the storage device 1040) (S214). At this time, for example, the image collection unit 150 may receive an input of additional information used in learning of the product identification engine via the input apparatus (such as a keyboard and a touch panel) connected to the store apparatus 10. For example, the display control unit 140 may receive an input of information (hereinafter, expressed as “product determination information”) indicating what the product P is, and store the product determination information in association with the image acquired in the processing in S212 (for example: FIG. 5). FIG. 5 is a diagram illustrating one example of information stored in a predetermined storage apparatus by the image collection unit 150. FIG. 5 illustrates the information in which an image (or a feature value of the image) acquired by the image acquisition unit 110 and the product determination information (for example, a name of a product, identification information assigned to each product, and the like) about a product placed on the display 40 are associated with each other.

As described above, according to the present example embodiment, an image usable in learning of a discriminator for identifying a product can be collected in an apparatus that performs general register work. In other words, the apparatus that performs general register work can function as an apparatus constructing a discriminator. In this way, a cost for constructing a discriminator can be reduced. Further, according to the present example embodiment, any background image can be displayed on the display 40 in the image collection mode. In this way, an image suitable for learning of a discriminator can be easily produced.

### Second Example Embodiment

The present example embodiment has a configuration similar to that in the first example embodiment except for the following point.

### System Configuration Example

A store system 1 according to the present example embodiment has a configuration similar to the configuration as illustrated in FIG. 1, for example. A display control unit 140 according to the present example embodiment switches and displays a plurality of background images each having a different content on a display surface of a display 40 in an image collection mode. Then, an image collection unit 150 according to the present example embodiment acquires a plurality of learning images in which any of the plurality of background images described above and a product P placed on the display surface of the display 40 are captured.

Herein, the plurality of background images displayed on the display surface of the display 40 by the display control unit 140 may be images (for example, combination images each being formed of random geometrical figures, and the like) each being randomly generated. Further, for example, the plurality of background images may be, for example, a plurality of plain images having colors different from each other. Further, the plurality of background images may be images tuned for a usage environment of a product identification engine. For example, the plurality of background images may be images in which a product is captured. In this case, the plurality of background images have at least one of kinds and arrangements of the product different from each other. Further, in this case, noise other than the product may be included in at least a part of the plurality of background images. Specifically, a display content such as a screen actually displayed in work at a store and a graphical user interface (GUI), a hand or a finger of a person, or the like may be included as noise in at least a part of the plurality of background images. By including such noise in the background image, a situation that may actually occur in a usage environment (specifically, a system for collectively recognizing products to be purchased, which are placed on the display 40, by using an image capturing apparatus 30 in an upper portion) of the product identification engine can be accurately reconstituted.

Data about the plurality of background images as illustrated above are stored in a storage device 1040 and the like, for example, and the display control unit 140 can read the data about each of the background images from the storage device 1040 and the like. Further, when the plurality of background images tuned for a usage environment of the product identification engine are used, the display control unit 140 may be configured to generate the plurality of background images by combining a plurality of parts images stored in the storage device 1040 randomly or according to a predetermined rule.

### Hardware Configuration Example

The image collection system 1 according to the present example embodiment has a hardware configuration (for example: FIG. 2) similar to that in the first example embodiment. The storage device 1040 according to the present example embodiment further stores a program module that achieves a function of a positional information acquisition unit 160 described above. A processor 1020 reads the program module onto a memory 1030 and executes the program module, and thus the function of the position information acquisition unit 160 according to the present example embodiment is achieved.

### <Flow of Processing>

A rough flow of processing according to the present example embodiment is similar to that illustrated in FIG. 4. According to the present example embodiment, the display control unit 140 transmits, to the display 40, drawing data causing a plurality of background images to be switched and displayed at a predetermined timing in the processing in S206. Then, the display 40 displays the plurality of background images while switching the plurality of background images, based on the drawing data received from the display control unit 140. In this way, an image acquisition unit 110 can acquire a plurality of images in which any of the plurality of background images and a product P placed on the display surface of the display 40 are captured in the processing in S212. Then, the image collection unit 150 stores the plurality of images acquired in such a manner as learning images of the product identification engine in a predetermined storage apparatus (for example, the storage device 1040 and the like) in the processing in S214.

As described above, according to the present example embodiment, a plurality of background images are switched and displayed on the display surface of the display 40 on which the product P is placed in a mode for collecting a learning image of the product identification engine. In this way, various learning images can be more easily collected than the first example embodiment.

### Third Example Embodiment

The present example embodiment has a configuration similar to that in each of the example embodiments described above except for the following point.

### System Configuration Example

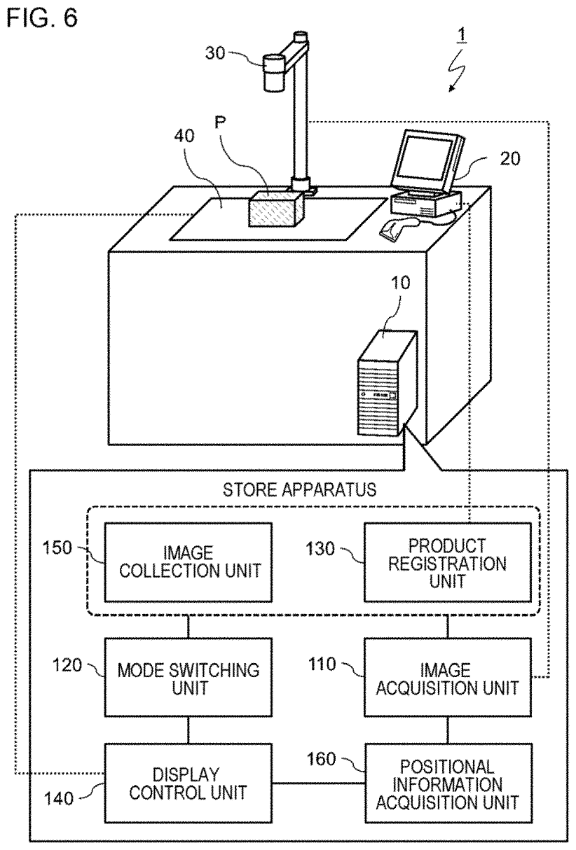

FIG. 6 is a diagram illustrating a configuration example of a store system 1 according to a third example embodiment. According to the present example embodiment, a store apparatus 10 further includes a positional information acquisition unit 160 that acquires a position of a product P placed on a display surface of a display 40. For example, the positional information acquisition unit 160 can detect a position of an object (product P) placed on the display surface of the display 40 from an image acquired by an image acquisition unit 110, by using various object detection algorithms. Then, a display control unit 140 according to the present example embodiment further displays, on the display surface of the display 40, information to be displayed according to a position of a product in a product registration mode, based on the position of the product P acquired by the positional information acquisition unit 160.

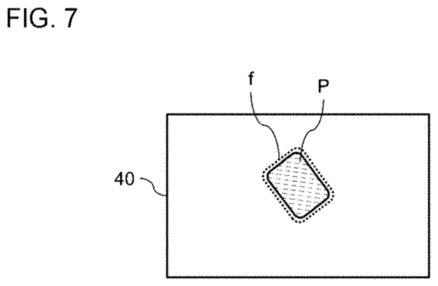

FIG. 7 illustrates one example of information displayed by the display control unit 140. FIG. 7 is a diagram illustrating one example of the information displayed on the display 40 by the display control unit 140 according to the third example embodiment. In the example in FIG. 7, the information displayed according to a position of a product in the product registration mode is a frame-shaped display element f displayed along a contour of the product P placed on the display 40. It should be noted that the display control unit 140 previously holds a transformation rule for transforming “coordinates in an image generated by an image capturing apparatus 30” to “coordinates on the display surface (placement surface of the product P) of the display 40”. Then, the display control unit 140 can transform a position (coordinates) of the product in the image to coordinates on the display surface of the display 40, based on the transformation rule, and display the frame-shaped display element fin such a way as to surround the transformed position, for example. Further, for example, the display control unit 140 may further display, according to a position of the product P, a GUI (for example, a button for registering a product as a purchase product, a cancel button of a product, and the like) displayed in response to an identification result of a product.

As described above, according to the present example embodiment, when a learning image in which an image displayed on the display surface of the display 40 and the product P placed on the display surface of the display 40 are captured is collected, information displayed in response to an identification result of a product identification engine in the product registration mode is further displayed. In this way, an image for a discriminator to learn not to recognize by mistake, as a part of a product, a region of information displayed in response to an identification result of a product during the product registration mode can be generated.

### Fourth Example Embodiment

The present example embodiment is similar to each of the example embodiments described above except for the following point.

### System Configuration Example

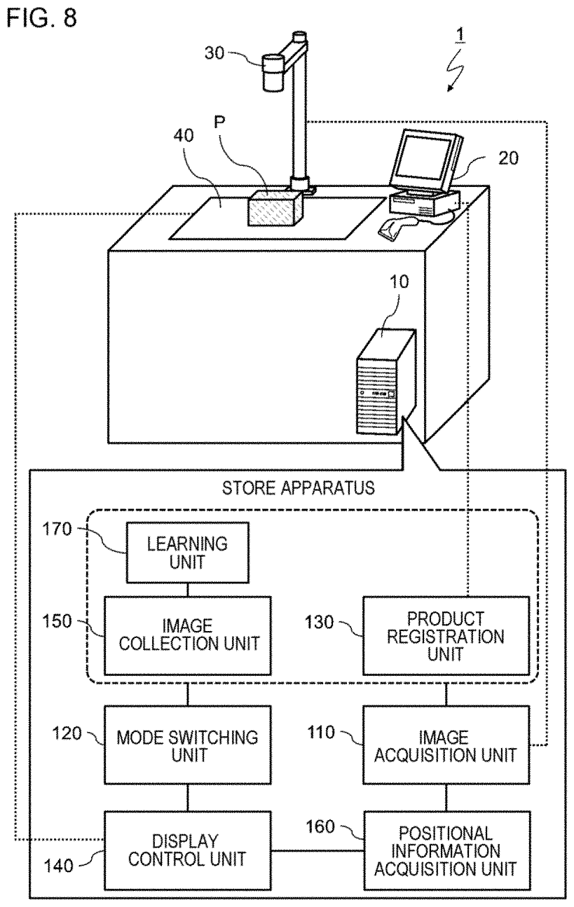

FIG. 8 is a diagram illustrating a configuration example of a store system 1 according to a fourth example embodiment. It should be noted that, the example in FIG. 8 is based on the configuration according to the third example embodiment. According to the present example embodiment, a store apparatus 10 further includes a learning unit 170. The learning unit 170 performs learning of a product identification engine (discriminator) by using a learning image collected by an image collection unit 150.

### Hardware Configuration Example

The image collection system 1 according to the present example embodiment has a hardware configuration (for example: FIG. 2) similar to that in the first example embodiment. A storage device 1040 according to the present example embodiment further stores a program module that achieves a function of the learning unit 170 described above. A processor 1020 reads the program module onto a memory 1030 and executes the program module, and thus the function of the learning unit 170 according to the present example embodiment is achieved.

### <Flow of Processing>

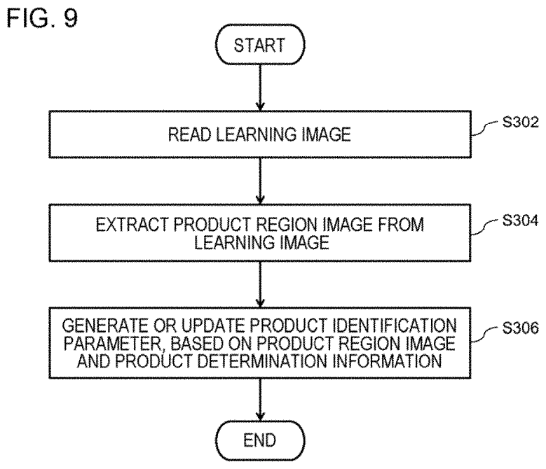

A flow of processing executed by the store system 1 according to the present example embodiment will be described by using FIG. 9. FIG. 9 is a flowchart illustrating a flow of learning processing executed by the store system 1 according to the fourth example embodiment.

The learning unit 170 reads learning images stored (collected) in a predetermined storage apparatus in the processing in S214 in FIG. 4 (S302). For example, the learning unit 170 can read all or a part of learning images stored in the predetermined storage apparatus according to a selection input of a user who uses the store system 1 or randomly. Then, the learning unit 170 performs learning of the product identification engine by using the read learning image.

The learning unit 170 can perform learning of the product identification engine as follows, for example. The learning unit 170 extracts a product region image indicating a region of a product placed on a display surface of a display 40 from the learning image collected by the image collection unit 150 (S304). For example, it is assumed that the learning image includes information (for example: a frame-shaped display element f) indicating a presence position of the product as illustrated in FIG. 7. In this case, the learning unit 170 detects the information (for example: the frame-shaped display element f) indicating the presence position of the product from the learning image. Then, the learning unit 170 can extract the product region image, based on a detected position of the information (for example: the frame-shaped display element f) indicating the presence position of the product. Specifically, the learning unit 170 can generate the product region image by cutting out a region inside the information (for example: the frame-shaped display element f) indicating the presence position of the product. Further, when the information (for example: the frame-shaped display element f) indicating the presence position of the product is not included in the learning image, the learning unit 170 may cause a user to specify a region of the product. In this case, the learning unit 170 can receive a specification input of a user via a keyboard, a touch panel, and the like. Then, the learning unit 170 can extract the specified region as the product region image. It should be noted that, when product determination information is not associated with a learning image, the learning unit 170 may further receive an input of the product determination information.

Then, the learning unit 170 generates or updates, based on the product region image extracted from the learning image and the product determination information associated with the learning image, an identification parameter of the product determined by the product determination information (S306). When the identification parameter of the product determined by the product determination information is not present in the product identification engine, the learning unit 170 generates the identification parameter of the product by using the extracted product region image. Further, when the identification parameter of the product determined by the product determination information is present in the product identification engine, the learning unit 170 updates the product identification parameter by using the product region image.

In this way, the store system 1 according to the present example embodiment can easily construct a product identification engine (discriminator) by using a learning image generated in each of the example embodiments described above.

### Fifth Example Embodiment

The present example embodiment is similar to the fourth example embodiment except for the following point.

### System Configuration Example

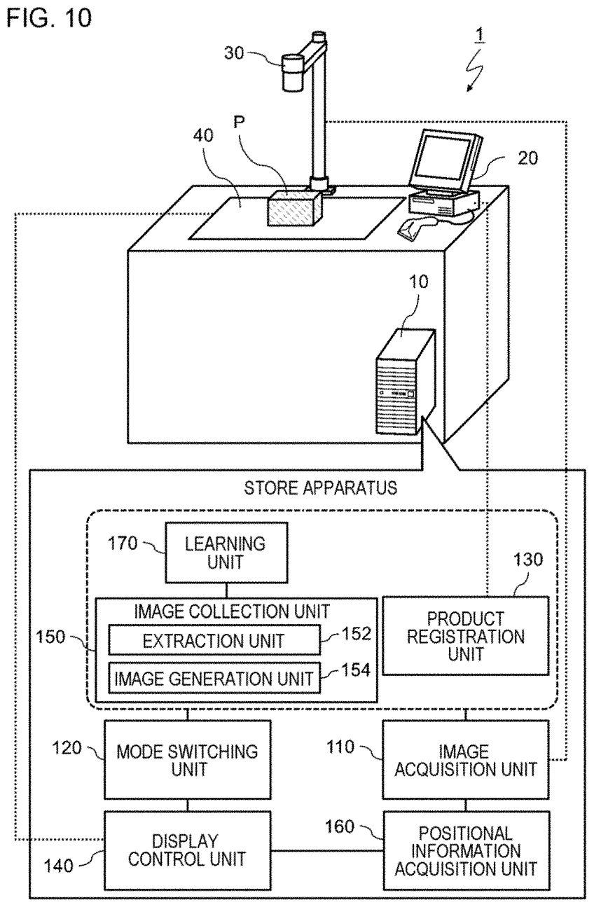

FIG. 10 is a diagram illustrating a configuration example of a store system 1 according to a fifth example embodiment. According to the present example embodiment, an image collection unit 150 further includes an extraction unit 152 and an image generation unit 154. The extraction unit 152 extracts a partial image (hereinafter, expressed as a “product region image”) indicating a region of a product from a captured image generated by an image capturing apparatus 30. It should be noted that a specific example of an operation of the extraction unit 152 will be described later. The image generation unit 154 generates a learning image by combining the product region image extracted by the extraction unit 152 with a predetermined base image, and stores the learning image in a predetermined storage apparatus. Herein, the base image is any image. For example, the base image is a monochrome plain image, an image including a geometric pattern, a character, and the like, a natural image, and the like. The base image may be an image acquired by optionally combining the images exemplified herein. The base image exemplified herein is previously stored in a storage device 1040. It should be noted that a plurality of types of base images may be stored in the storage device 1040. Further, for example, the predetermined storage apparatus may be a non-volatile storage apparatus such as a hard disk drive, and may be a volatile storage apparatus such as a random access memory (RAM).

### Hardware Configuration Example

The store system 1 according to the present example embodiment has a hardware configuration (for example: FIG. 2) similar to that in the first example embodiment. The storage device 1040 according to the present example embodiment further stores a program module that achieves functions of the extraction unit 152 and the image generation unit 154 described above. A processor 1020 reads the program module onto a memory 1030 and executes the program module, and thus the functions of the extraction unit 152 and the image generation unit 154 according to the present example embodiment are achieved.

### <Flow of Processing>

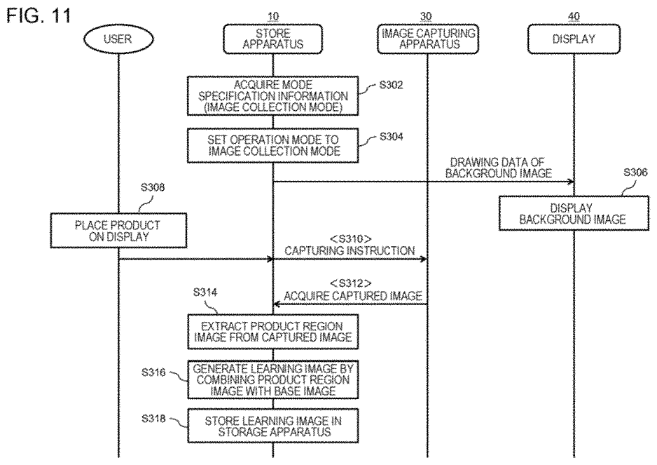

A flow of processing executed by the store system 1 according to the present example embodiment will be described by using FIG. 11. FIG. 11 is a sequence diagram illustrating the flow of the processing of the store system 1 according to the fifth example embodiment.

The flow of the processing from S302 to S312 according to the present example embodiment is similar to that of the processing from S202 to S212 in FIG. 4.

The extraction unit 152 extracts a product region image indicating a region of a product from a captured image generated by the image capturing apparatus 30 (S316). Hereinafter, various specific techniques of extracting a product region image from a captured image will be illustrated by using drawings.

### <First Technique>

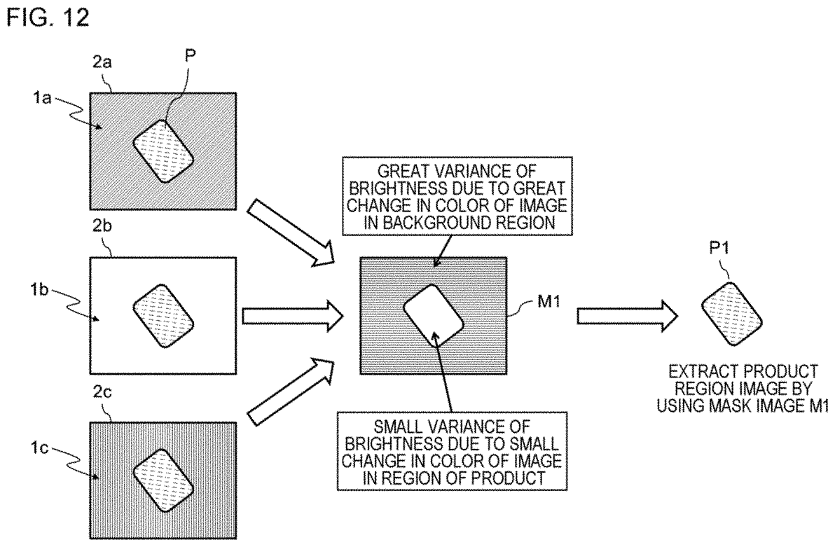

FIG. 12 is a diagram illustrating a first technique of extracting a product region image from a captured image. In the technique in FIG. 12, a display control unit 140 displays, on a display 40, plain images having colors different from each other as a plurality of background images having contents different from each other. FIG. 12 illustrates an example of using three background images (1a to 1c) respectively having red (hatched portion in the diagram), white (plain portion in the diagram), and blue (vertical line portion in the diagram) as ground colors. The images are stored in the storage device 1040, for example. It should be noted that FIG. 12 is merely exemplification, and a combination of colors of the background images and the number of colors are not limited to the example in FIG. 12. In this case, the image collection unit 150 can acquire a captured image (2a) in which the red background image (1a) and a product P are captured, a captured image (2b) in which the white background image (1b) and the product P are captured, and a captured image (2c) in which the blue background image (1c) and the product P are captured. Herein, the product P is placed on a display surface of the display 40. Thus, when the three captured images (2a to 2c) are compared, a change in color of the region in which the product P is placed is clearly smaller than a change in color of the display surface of the display 40. In other words, when the plurality of captured images are each compared, a change amount of brightness of the region in which the product P is placed is clearly smaller than a change amount of brightness of the other region (namely, the display surface of the display 40). Thus, the extraction unit 152 can extract a product region image by using the change amount of brightness among the plurality of captured images. Specifically, the extraction unit 152 first calculates a variance of brightness for each pixel of each of the three captured images (2a to 2c). Next, the extraction unit 152 determines, by using a predetermined threshold value, each of a set region (background region) of pixels having a variance of brightness exceeding the threshold value among the three captured images (2a to 2c), and a set region (foreground region, namely, a region of a product) of pixels having a change amount of brightness being less than the threshold value. The predetermined threshold value is defined in a program module of the extraction unit 152, for example. Next, the extraction unit 152 generates a mask image M1 that masks the background region, by using a result of the determination as described above. Then, the extraction unit 152 extracts a product region image P1 indicating a region of the product P from the captured image, by using the generated mask image M1. The extraction unit 152 stores, in the storage device 1040, the other storage apparatus, or the like, the generated mask image M1 and the extracted product region image P1 of the product P in association with information (for example, a product name, a product identification number, and the like) that identifies the product P.

### <Second Technique>

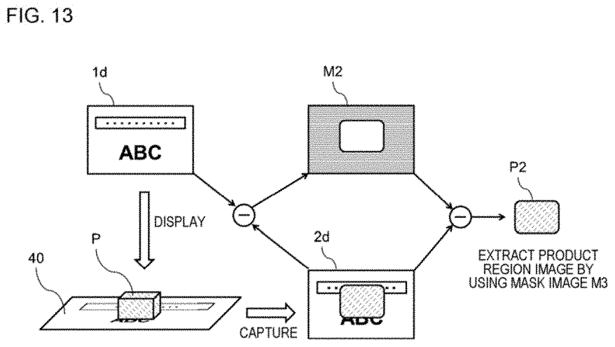

FIG. 13 is a diagram illustrating a second technique of extracting a product region image from a captured image. In the technique in FIG. 13, the display control unit 140 displays, on the display 40, a known background image (1d) as a predetermined background image. The known background image (1d) is stored in the storage device 1040, for example. The image capturing apparatus 30 captures an image after a product P is placed on the display 40 that displays the known background image (1d), and then the image collection unit 150 can acquire a captured image (2d) as illustrated. Herein, the product P is placed on the display surface of the display 40. Thus, a partial region of the known background image (1d) is hidden by the product P in the captured image (2d). In other words, the extraction unit 152 can determine, as a region of the product, a set region of pixels of the captured image (2d) different from the known background image (1d). Further, the extraction unit 152 can determine, as a background region, a set region of pixels of the captured image (2d) equal to the known background image (1d). Then, the extraction unit 152 generates a mask image M2 that masks the background region, by using a result of the determination as described above. Then, the extraction unit 152 extracts a product region image P2 indicating a region of the product P from the captured image, by using the generated mask image M2. The extraction unit 152 stores, in the storage device 1040, the other storage apparatus, or the like, the generated mask image M2 and the extracted product region image P2 of the product P in association with information (for example, a product name, a product identification number, and the like) that identifies the product P.

The second technique unlike the first technique uses a displacement of a pattern of a known image and the like, and determines a region of the product P. Thus, even when a product placed on the display 40 is a transparent object (for example, a drink in a plastic bottle and the like), a region of the product P can be accurately determined. It should be noted that the extraction unit 152 may use a plurality of known images in the second technique. In this case, the extraction unit 152 can determine a region of the product P, based on a result acquired by determining a set region of pixels different for each of the plurality of known images.

### <Third Technique>

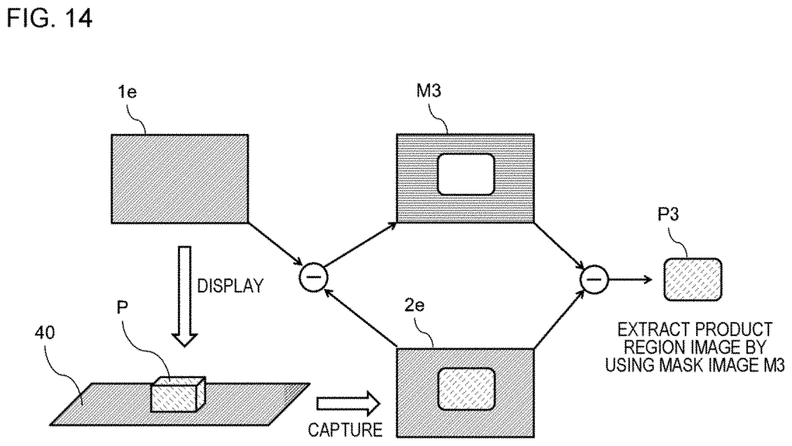

FIG. 14 is a diagram illustrating a third technique of extracting a product region image from a captured image. In the technique in FIG. 14, the display control unit 140 displays, on the display 40, a known background image (1e) as a predetermined background image. It should be noted that the third technique is different from the second technique in a point that a plain image is used as a known background image. The known background image (1e) is stored in the storage device 1040, for example. The image capturing apparatus 30 captures an image after the product P is placed on the display 40 that displays the known background image (1e), and then the image collection unit 150 can acquire a captured image (2e) as illustrated. Herein, the product P is placed on the display surface of the display 40. Thus, a partial region of the known background image (1e) is hidden by the product P in the captured image (2e). Furthermore, since the known background image (1e) is plain, the extraction unit 152 can determine, as a region of the product, a set region of pixels of the captured image (2e) having a color different from that of the known background image (1e). Further, the extraction unit 152 can determine, as a background region, a set region of pixels of the captured image (2e) having the same color as that of the known background image (1e). Then, the extraction unit 152 generates a mask image M3 that masks the background region, by using a result of the determination as described above. Then, the extraction unit 152 extracts a product region image P3 indicating a region of the product P from the captured image, by using the generated mask image M3. The extraction unit 152 stores, in the storage device 1040, the other storage apparatus, or the like, the generated mask image M3 and the extracted product region image P3 of the product P in association with information (for example, a product name, a product identification number, and the like) that identifies the product P.

The third technique extracts a region of the product P, based on a color of a background image. Thus, the third technique unlike the first technique of using a variance of brightness can also handle a translucent product.

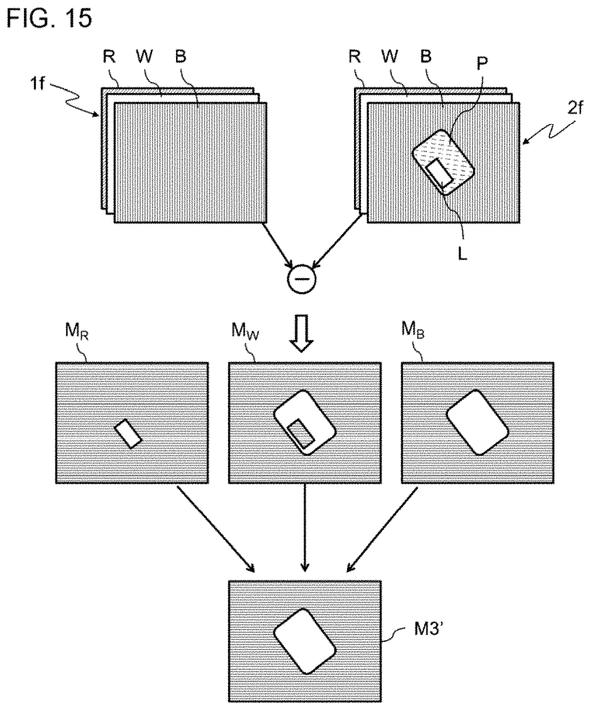

It should be noted that known background images may be a plurality of images each having a different color in the third technique (for example: FIG. 15). FIG. 15 is a diagram illustrating another example of the third technique. FIG. 14 illustrates known three background images (1f) respectively having red (hatched portion R in the diagram), white (plain portion W in the diagram), and blue (vertical line portion B in the diagram). Note that it is assumed that a color of a package of the product P is red and a white label L is stuck on the product P in the example in FIG. 15. In this case, the extraction unit 152 can generate mask images (color-specific mask images M_{R}, M_{W}, and M_{B}) for red, white, and blue similarly to the flow described in FIG. 14. The color-specific mask image M_{R} is an image that masks a red region. Further, the color-specific mask image M_{W} is an image that masks a white region. Further, the color-specific mask image M_{B} is an image that masks a blue region. As illustrated, the color-specific mask image M_{R} includes a package portion (a red region except for a region of the white label L) of the product in the mask region. Further, the color-specific mask image M_{W} includes the region of the white label L stuck on the product in the mask region. In such a case, the extraction unit 152 can generate a final mask image M3′ from an AND operation of the mask regions of the color-specific mask images M_{R}, M_{W}, and M_{B}, for example. Then, the extraction unit 152 can extract a product region image indicating a region of the product P from a captured image, by using the generated mask image M3′. In this way, for example, even when a color of at least a part of a product is coincidentally the same as a color of a background image, a mask image that accurately extracts a region of the product can be generated.

### <Fourth Technique>

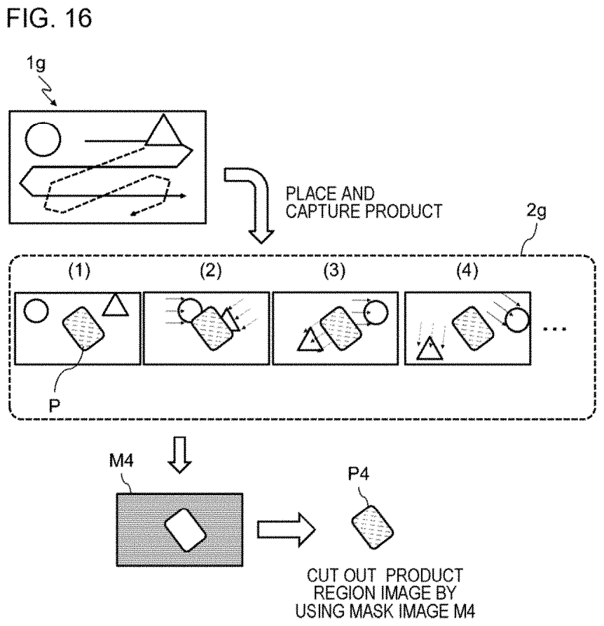

FIG. 16 is a diagram illustrating a fourth technique of extracting a product region image from a captured image. In the technique in FIG. 16, the display control unit 140 displays, on the display 40, a moving image (1g) as a predetermined background image. An example of FIG. 16 illustrates the moving image (1g) in which two figures (circle and triangle) move with time. It should be noted that the positional information acquisition unit 160 can display any moving image, which is not limited to the example in FIG. 16. In this case, the image collection unit 150 can acquire a plurality of captured images as indicated by a reference sign 2g in FIG. 16, for example. Herein, a product P is placed on the display surface of the display 40. Thus, at least a part of the figure moving in the moving image (1g) may be hidden by the product P in the captured image (2g) (for example: 2g (2)). In other words, a movement is smaller in a region in which the product P is placed than in a moving image portion in the background in the plurality of captured images. Thus, the extraction unit 152 can determine, as a region of the product, a set region (a region of an object remaining still) of pixels having a small movement in the plurality of captured images. Specifically, the extraction unit 152 can determine a region of the product by using an optical flow, a background difference, and the like. Further, the extraction unit 152 can determine, as a background region, a set region of pixels of having a certain movement or more. Then, the extraction unit 152 generates a mask image M4 that masks the background region, by using a result of the determination as described above. Then, the extraction unit 152 extracts a product region image P4 indicating a region of the product P from the captured image, by using the generated mask image M4. The extraction unit 152 stores, in the storage device 1040, the other storage apparatus, or the like, the generated mask image M4 and the extracted product region image P4 of the product P in association with information (for example, a product name, a product identification number, and the like) that identifies the product P.

It should be noted that, when a plurality of objects are simultaneously placed on the display 40 in each of the techniques described above, the extraction unit 152 can store, for each individual object, a mask image and a product region image of the object in the storage apparatus as follows. Specifically, the extraction unit 152 first divides an acquired mask image into individual regions by a connection component analysis and the like, and generates a mask image for each object. Then, the extraction unit 152 stores, in the storage apparatus, the mask image for each object and a product region image of the object extracted by the mask image in association with information that identifies the object.

Further, the extraction unit 152 may store, in the storage apparatus, a captured image acquired by the image acquisition unit 110 instead of the product region image. Also, in this case, a product region image of a product as a target can be generated as necessary by using the captured image and a mask image stored in the storage apparatus.

Referring back to FIG. 11, the image generation unit 154 generates a learning image by combining the product region image extracted in the processing in S314 with a predetermined base image (S316). It should be noted that the image generation unit 154 may generate a learning image by using a product region image of another product extracted in past processing in addition to the product region image extracted in the processing in S314. The product region image of the another object extracted in the past processing is accumulated in the storage device 1040, for example. In this case, the image generation unit 154 can select a product region image to be read from the storage device 1040 according to a selection input of a user or a preset rule. Further, the image generation unit 154 may randomly select a kind and the number of product region images to be combined with a base image.

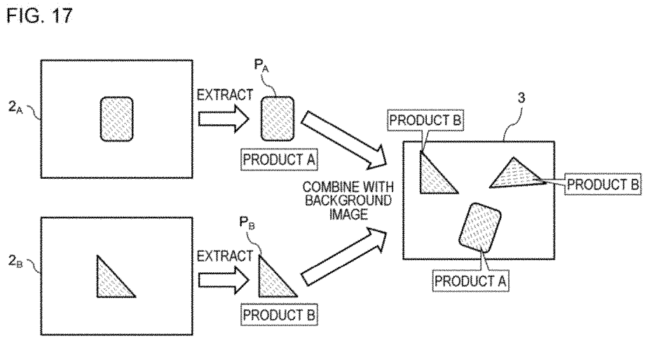

An operation of the image generation unit 154 will be specifically described by using FIG. 17. FIG. 17 is a diagram specifically illustrating the operation of the image generation unit 154. In the example in FIG. 17, it is assumed that a product region image P_{A} of a product A and a product region image P_{B} of a product B are generated from captured images 2_{A} and 2_{B} of two objects (product A and product B), respectively. In this case, the image generation unit 154 can generate a learning image as indicated by a reference sign 3, for example, by combining the product region image P_{A} of the product A and the product region image P_{B} of the product B with a predetermined base image. As illustrated, the image generation unit 154 can process (rotate, move, and the like) the product region image P_{A} of the product A and the product region image P_{B} of the product B. Further, the image generation unit 154 can determine the number of arrangements of the product region image P_{A} of the product A and the product region image P_{B} of the product B. The image generation unit 154 can determine a way of processing and the number of arrangements according to a specification input of a user or a predetermined rule, or completely randomly. Further, the image generation unit 154 generates a list of product region images combined with a base image during generation of a learning image. For example, the list stores, for each product region image combined with the base image, positional coordinates in the base image and information (or information simply indicating that it is a product) that can individually identify a product, such as a name of a product and an identification number. In other words, the list can be used as information indicating which product is present in which position in the learning image.

The image generation unit 154 stores the third image and the list generated as described above in a predetermined storage apparatus such as the memory 130 and the storage device 1040 (S318). In this way, the image generation unit 154 according to the present example embodiment can generate a numerous number of images according to various situations by using a product region image. Then, the learning unit 170 can perform learning of a discriminator with a learning image and a list as an input.

As described above, in the store system 1 according to the present example embodiment, a captured image including the product P and a background image is generated by displaying the background image on the display surface of the display 40 when the product P placed on the display 40 is captured. Then, based on a characteristic generated in the captured image by the product P being placed on the display 40 that displays the background image, a product region image indicating a region of the product P is extracted from the captured image. Then, a learning image is generated by combining the extracted product region image with a predetermined base image.

The store system 1 according to the present example embodiment can easily generate an image having a numerous number of patterns as a learning image of a product identification engine (discriminator) by using the extracted product region image. In other words, the store system 1 according to the present example embodiment improves efficiency of generating an image for optimizing the discriminator, and can thus reduce time and effort when the discriminator used in product recognition is constructed.

While the example embodiments of the present invention have been described with reference to the drawings, the example embodiments are only exemplification of the present invention, and various configurations other than the above-described example embodiments can also be employed.

For example, the present invention is applicable to not only a general method in which an operation from registration of a purchase product to payment of a price is performed on a salesclerk apparatus but also a so-called semi-self method and a self method. In the semi-self method, a register apparatus for product registration and a checkout apparatus for a payment are separately provided. The register apparatus for the product registration can have the function of the store apparatus 10 described above. Further, in the self method, registration of a purchase product to payment of a price is performed on an apparatus operated by a customer. The apparatus operated by a customer can have the function of the store apparatus 10 described above.

Further, the plurality of steps (processing) are described in order in the plurality of sequence diagrams and flowcharts used in the above-described description, but an execution order of steps performed in each of the example embodiments is not limited to the described order. In each of the example embodiments, an order of illustrated steps may be changed within an extent that there is not harm in context. Further, each of the example embodiments described above can be combined within an extent that a content is not inconsistent.

A part or the whole of the above-mentioned example embodiment may also be described in supplementary notes below, which is not limited thereto.

1.

A store apparatus, including:

an image acquisition unit that acquires, from an image capturing apparatus, an image in which a product placed on a display surface of a display is captured;

a mode switching unit that switches between a product registration mode for registering a product to be purchased by a customer and an image collection mode for collecting a learning image of a discriminator for identifying a product;

a product registration unit that registers, during the product registration mode, a product identified by the discriminator, based on the image, as a product to be purchased;

a display control unit that displays, during the image collection mode, a predetermined background image on the display surface of the display; and

an image collection unit that stores, in a predetermined storage apparatus, an image in which the background image and the product are captured, as the learning image.

2.

The store apparatus according to supplementary note 1,

in which the display control unit switches and displays a plurality of background images each having a different content on the display surface of the display during the image collection mode, and

the image collection unit stores, in a predetermined storage apparatus, a plurality of images in which any of the plurality of background images and a product placed on the display are captured, as the learning image.

3.

The store apparatus according to supplementary note 2, in which the display control unit displays plain images having colors different from each other as the plurality of background images.

4.

The store apparatus according to any one of supplementary notes 1 to 3, further including a position acquisition unit that acquires a position of a product placed on the display surface of the display,

in which the display control unit further displays information displayed according to a presence position of the product in the product registration mode, based on the position of the product acquired by the position acquisition means.

5.

The store apparatus according to any one of supplementary notes 1 to 4, further including a learning unit that performs learning of the discriminator by using the learning image collected by the image collection means.

6.

The store apparatus according to supplementary note 5,

in which the learning unit
extracts a product region image indicating a region of a product placed on the display from the learning image, and
performs learning of the discriminator by using the extracted product region image.
   7.

The store apparatus according to supplementary note 6,

in which the learning unit
detects information indicating a presence position of a product placed on the display from the learning image, and
extracts the product region image, based on a detected position of the information in the learning image.
   8.

A store system, including:

a display including a display surface used as a placement surface of a product;

an image capturing apparatus that generates an image in which a product placed on the display surface of the display is captured;

an image acquisition unit that acquires the image generated by the image capturing apparatus;

a mode switching unit that switches between a product registration mode for registering a product to be purchased by a customer and an image collection mode for collecting a learning image of a discriminator for identifying a product;

a product registration unit that registers, during the product registration mode, a product identified by the discriminator, based on the image, as a product to be purchased;

a display control unit that displays, during the image collection mode, a predetermined background image on the display surface of the display; and

an image collection unit that stores, in a predetermined storage apparatus, an image in which the background image and the product are captured, as the learning image.

9.

The store system according to supplementary note 8,

in which the display control unit switches and displays a plurality of background images each having a different content on the display surface of the display during the image collection mode, and

the image collection unit stores, in a predetermined storage apparatus, a plurality of images in which any of the plurality of background images and a product placed on the display are captured, as the learning image.

10.

The store system according to supplementary note 9, in which the display control unit displays plain images having colors different from each other as the plurality of background images.

11.

The store system according to any one of supplementary notes 8 to 10, further including a position acquisition unit that acquires a position of a product placed on the display surface of the display,

in which the display control unit further displays information displayed according to a presence position of a product in the product registration mode, based on the position of the product acquired by the position acquisition means.

12.

The store system according to any one of supplementary notes 8 to 11, further including a learning unit that performs learning of the discriminator by using the learning image collected by the image collection means.

13.

The store system according to supplementary note 12,

in which the learning unit
extracts a product region image indicating a region of a product placed on the display from the learning image, and
performs learning of the discriminator by using the extracted product region image.
   14.

The store system according to supplementary note 13,

in which the learning unit
detects information indicating a presence position of a product placed on the display from the learning image, and
extracts the product region image, based on a detected position of the information in the learning image.
   15.

An image acquisition method executed by a computer including:

acquiring, from an image capturing apparatus, an image in which a product placed on a display surface of a display is captured;

switching between a product registration mode for registering a product to be purchased by a customer and an image collection mode for collecting a learning image of a discriminator for identifying a product;

registering, during the product registration mode, a product identified by the discriminator, based on the image, as a product to be purchased;

displaying, during the image collection mode, a predetermined background image on the display surface of the display; and

storing, in a predetermined storage apparatus, an image in which the background image and the product are captured, as the learning image.

16.

The image acquisition method according to supplementary note 15, further including:

switching and displaying a plurality of background images each having a different content on the display surface of the display during the image collection mode; and

storing, in a predetermined storage apparatus, a plurality of images in which any of the plurality of background images and a product placed on the display are captured, as the learning image.

17.

The image acquisition method according to supplementary note 16, further including displaying plain images having colors different from each other as the plurality of background images.

18.

The image acquisition method according to any one of supplementary notes 15 to 17, further including:

acquiring a position of a product placed on the display surface of the display; and

further displaying information displayed according to a presence position of a product in the product registration mode, based on the acquired position of a product.

19.

The image acquisition method according to any one of supplementary notes 15 to 18, further including,

performing learning of the discriminator by using the collected learning image.

20.

The image acquisition method according to supplementary note 19, further including:

extracting a product region image indicating a region of a product placed on the display from the learning image; and

performing learning of the discriminator by using the extracted product region image.

21.

The image acquisition method according to supplementary note 20, further including:

detecting information indicating a presence position of a product placed on the display from the learning image; and

extracting the product region image, based on a detected position of the information in the learning image.

22.

A program causing a computer to execute the image acquisition method according to any one of supplementary notes 15 to 21.

1. A store apparatus, comprising:
image acquisition unit that acquires, from an image capturing apparatus, an image in which a product placed on a display surface of a display is captured;
mode switching unit that switches between a product registration mode for registering a product to be purchased by a customer and an image collection mode for collecting a learning image of a discriminator for identifying a product;
product registration unit that registers, during the product registration mode, a product identified by the discriminator, based on the image, as a product to be purchased;
display control unit that displays, during the image collection mode, a predetermined background image on the display surface of the display; and
image collection unit that stores, in a predetermined storage apparatus, an image in which the background image and the product are captured, as the learning image.

2. The store apparatus according to claim 1, wherein
the display control unit switches and displays a plurality of background images each having a different content on the display surface of the display during the image collection mode, and
the image collection unit stores, in a predetermined storage apparatus, a plurality of images in which any of the plurality of background images and a product placed on the display are captured, as the learning image.

3. The store apparatus according to claim 2, wherein the display control unit displays plain images having colors different from each other as the plurality of background images.

4. The store apparatus according to claim 1, further comprising position acquisition unit that acquires a position of a product placed on the display surface of the display,
wherein the display control unit further displays information displayed according to a presence position of a product in the product registration mode, based on the position of a product acquired by the position acquisition means.

5. The store apparatus according to claim 1, further comprising learning unit that performs learning of the discriminator by using the learning image collected by the image collection means.

6. The store apparatus according to claim 5, wherein
the learning unit
extracts a product region image indicating a region of a product placed on the display from the learning image, and
performs learning of the discriminator by using the extracted product region image.

7. The store apparatus according to claim 6, wherein
the learning unit
detects information indicating a presence position of a product placed on the display from the learning image, and
extracts the product region image, based on a detected position of the information in the learning image.

8. A store system, comprising:
a display including a display surface used as a placement surface of a product;
an image capturing apparatus that generates an image in which a product placed on the display surface of the display is captured;
image acquisition unit that acquires the image generated by the image capturing apparatus;
mode switching unit that switches between a product registration mode for registering a product to be purchased by a customer and an image collection mode for collecting a learning image of a discriminator for identifying a product;
product registration unit that registers, during the product registration mode, a product identified by the discriminator, based on the image, as a product to be purchased;
display control unit that displays, during the image collection mode, a predetermined background image on the display surface of the display; and
image collection unit that stores, in a predetermined storage apparatus, an image in which the background image and the product are captured, as the learning image.

9. An image acquisition method executed by a computer comprising:
acquiring, from an image capturing apparatus, an image in which a product placed on a display surface of a display is captured;
switching between a product registration mode for registering a product to be purchased by a customer and an image collection mode for collecting a learning image of a discriminator for identifying a product;
registering, during the product registration mode, a product identified by the discriminator, based on the image, as a product to be purchased;
displaying, during the image collection mode, a predetermined background image on the display surface of the display; and
storing, in a predetermined storage apparatus, an image in which the background image and the product are captured, as the learning image.

10. (canceled)
